(19) United States
(12) Patent Application Publication
(10) Pub. No.: US 2024/0356742 A1
(43) Pub. Date: Oct. 24, 2024

(54) VERIFICATION OF SERVICE BASED ARCHITECTURE PARAMETERS

(71) Applicant: TELEFONAKTIEBOLAGET LM ERICSSON (PUBL), STOCKHOLM (SE)

(72) Inventors: Vlasios Tsiatsis, STOCKHOLM (SE); Cheng Wang, SHANGHAI (CN); Christine Jost, DALBY (SE); Songmao Li, SHANGHAI (CN); Helena Vahidi Mazinani, LUND (SE)

(21) Appl. No.: 18/682,787

(22) PCT Filed: Jul. 15, 2022
(86) PCT No.: PCT/IB2022/056560

§ 371 Date: Feb. 9, 2024

(30) Foreign Application Priority Data
Aug. 9, 2021 (WO) PCT/CN2021/111517

(51) Int. Cl. H04L 9/08

(52) U.S. Cl. CPC H04L 9/0861

(57) ABSTRACT

Systems and methods are disclosed herein that relate to verifying that a particular Application Function (AF) is authorized to use a particular AF ID in association with an Authentication and Key Management for Applications (AKMA) related procedure in a core network of a cellular communications system. In one embodiment, a method performed by an AKMA Anchor Function (AAnF) in a core network of the cellular communications system for generating a shared secret key for AKMA comprises receiving, directly or indirectly from an AF, a request for a shared secret key for AKMA, the request comprising an AF ID. The method further comprises determining whether the AF is authorized to use the AF ID and performing one or more actions based on a result of determining whether the AF (404) is authorized to use the AF ID.

### TECHNICAL FIELD

The present disclosure relates to verification of Service Based Architecture (SBA) parameters.

### BACKGROUND

In the context of Authentication and Key Management for Applications (AKMA) described in Third Generation Partnership Project (3GPP) Technical Specification (TS) 33.535 (see, e.g., v17.2.1), an Application Function (AF) requests a shared secret (i.e., the AKMA Application Key, K_{AF}) from an AKMA Anchor Function (AAnF) by providing an application function identity (AF_ID). The AF_ID consists of the AF Fully Qualified Domain Name (FQDN) and a Ua* protocol identifier.

FIG. 1 and FIG. 2 show the different aspects of the AKMA KAF retrieval process. FIG. 1 shows how an internal AF (i.e., an AF that is internal to the Fifth Generation Core (5GC)) requests an application key from the AAnF while FIG. 2 shows how an external AF requests an application key from the AAnF via a Network Exposure Function (NEF) in the 5GC.

The AF_ID is used for authorization decisions by the AAnF as well as for the key derivation of the shared secret K_{AF}. As a result, the AF_ID is an important parameter to be passed to the AAnF and, therefore, the AAnF should verify that the AF is authorized to use the AF_ID in an AKMA interaction. Again, see FIG. 1 and FIG. 2 for the different aspects of the AKMA KAF retrieval.

In the 3GPP Fifth Generation (5G) architecture, network functions (NFs) use the Service Based Architecture (SBA) to interact with each other. An NF consumer (cNF) invokes SBA service operations from the NF producer (pNF). The SBA interactions are based on direct Transport Layer Security (TLS) connections for direct NF to NF interaction or hop by hop TLS connections with Client Credentials Assertions (CCA) for indirect NF interaction. Moreover, the cNF may present (directly or indirectly) an authorization token to the pNF upon service invocation.

There are two kinds of TLS certificates: (a) the TLS certificates used for securing the communication between NFs in direct communication and (b) the TLS certificates used for signing the CCA in the case of indirect communication.

In the case of AKMA, for the internal case, the SBA cNF is the AF and the SBA pNF is the AAnF for the internal AF case. For the external case, the SBA cNF is the NEF and the SBA pNF is the AAnF.

### SUMMARY

Systems and methods are disclosed herein that relate to verifying that a particular Application Function (AF) is authorized to use a particular AF ID in association with an Authentication and Key Management for Applications (AKMA) related procedure in a core network of a cellular communications system. In one embodiment, a method performed by an AKMA Anchor Function (AAnF) in a core network of the cellular communications system for generating a shared secret key for AKMA comprises receiving, directly or indirectly from an AF, a request for a shared secret key for AKMA, the request comprising (at least) an AF ID (which is sometimes denoted herein as “AF_ID”). The method further comprises determining whether the AF is authorized to use the AF ID and performing one or more actions based on a result of determining whether the AF (404) is authorized to use the AF ID. In this manner, the AAnF is enabled to verify that the AF is authorized to use the AF_ID in an AKMA interaction so as to avoid any other AF impersonating the specific AF with the specific AF ID.

In one embodiment, the AF ID comprises an AF Fully Qualified Domain Name, FQDN, and a Ua* protocol identifier. Note that the Ua* is a variant of the Ua interface (see 3GPP TS 33.220) referring to the interface between the UE and the AF. The Ua* protocol identifier is an identifier that is associated with a security protocol over Ua*.

In one embodiment, an associated certificate comprises information comprising: (a) an AF FQDN, (b) information that indicates a set of AF FQDNs, (c) an AF ID, (d) information that indicates a set of AF IDs, or (e) a combination of any two or more of (a)-(d). In one embodiment, the associated certificate is a certificate used for securing communication between the AAnF and the AF in the case of direct communication between the AAnF and the AF or a certificate used for signing Client Credentials Assertions (CCA) in the case indirect communication between the AAnF and the AF. In one embodiment, determining whether the AF is authorized to use the AF ID comprises determining whether the AF is authorized to use the AF ID based on a comparison of the AF ID comprised in the request for the shared secret key for AKMA and the information comprised in the associated certificate. In one embodiment, determining whether the AF is authorized to use the AF ID based on the comparison of the AF ID comprised in the request for the shared secret key for AKMA and the information comprised in the associated certificate comprises determining that the AF is authorized to use the AF ID if there is a match between the AF ID comprised in the request for the shared secret key for AKMA and the information comprised in the associated certificate.

In one embodiment, associated CCA comprise information comprising: (a) an AF FQDN, (b) information that indicates a set of AF FQDNs, (c) an AF ID, (d) information that indicates a set of AF IDs, or (e) a combination of any two or more of (a)-(d). In one embodiment, the associated CCA are CCA associated to hop by hop TLS connections in the case of indirect communication between the AAnF and the AF. In one embodiment, determining whether the AF is authorized to use the AF ID comprises determining whether the AF is authorized to use the AF ID based on a comparison of the AF ID comprised in the request for the shared secret key for AKMA and the information comprised in the associated CCA. In one embodiment, determining whether the AF is authorized to use the AF ID based on the comparison of the AF ID comprised in the request for the shared secret key for AKMA and the information comprised in the associated CCA comprises determining that the AF is authorized to use the AF ID if there is a match between the AF ID comprised in the request for the shared secret key for AKMA and the information comprised in the associated CCA.

In one embodiment, an associated authorization token comprises information comprising: (a) an AF FQDN, (b) information that indicates a set of AF FQDNs. (c) an AF ID. (d) information that indicates a set of AF IDs, or (e) a combination of any two or more of (a)-(d). In one embodiment, the associated authorization token is an authorization token presented to the AAnF upon invocation of an associated AKMA service. In one embodiment, determining whether the AF is authorized to use the AF ID comprises determining whether the AF is authorized to use the AF ID based on a comparison of the AF ID comprised in the request for the shared secret key for AKMA and the information comprised in the associated authorization token. In one embodiment, determining whether the AF is authorized to use the AF ID based on the comparison of the AF ID comprised in the request for the shared secret key for AKMA and the information comprised in the associated authorization token comprises determining that the AF is authorized to use the AF ID if there is a match between the AF ID comprised in the request for the shared secret key for AKMA and the information comprised in the associated authorization token.

In one embodiment, determining whether the AF is authorized to use the AF ID comprises determining whether the AF is authorized to use the AF ID based on asserted AF information.

In one embodiment, determining whether the AF is authorized to use the AF ID comprises providing a verification request to a mapping network function (NF), the verification request comprising the AF ID, and receiving a verification response from the mapping NF. In one embodiment, the verification response comprises information that indicates whether the AF is authorized to use the AF ID. In another embodiment, determining whether the AF is authorized to use the AF ID further comprises determining whether the AF is authorized to use the AF ID based on the verification response. In one embodiment, the verification request further comprises an Instance ID of the AF. In one embodiment, the mapping NF stores associations between Instance IDs and AF IDs, sets of AF IDs, FQDNs, or sets of FQDNs. In one embodiment, the verification request further comprises CCA unique information associated to the AF. In one embodiment, the mapping NF stores associations between CCA unique information and AF IDs, sets of AF IDs, FQDNs, or sets of FQDNs.

In one embodiment, determining whether the AF is authorized to use the AF ID comprises determining that the AF is authorized to use the AF ID and performing the one or more actions based on the result of determining whether the AF is authorized to use the AF ID comprises, responsive to determining that the AF is authorized to use the AF ID, deriving the shared secret key for AKMA and sending, directly or indirectly to the AF, a response message that comprises the shared secret key for AKMA.

Embodiments of a method performed by mapping NF in a core network of the cellular communications system are also disclosed. In one embodiment, a method performed by a mapping NF comprises receiving a verification request from an AAnF, the verification request comprising an AF ID. The method further comprises determining whether a particular AF is authorized to use the AF ID and sending a verification response to the AAnF, the verification response comprising information that indicates whether the particular AF is authorized to use the AF ID.

In one embodiment, the verification request further comprises a NF Instance ID of the particular AF, and determining whether the particular AF is authorized to use the AF ID comprises determining whether the particular AF is authorized to use the AF ID based on the NF Instance ID of the particular AF and stored associations between NF Instance IDs and AF IDs or sets of AF IDs.

In one embodiment, the verification request further comprises CCA unique information associated to the particular AF, and determining whether the particular AF is authorized to use the AF ID comprises determining whether the particular AF is authorized to use the AF ID based on the CCA unique information associated to the particular AF and stored associations between CCA unique information and AF IDs or sets of AF IDs.

Corresponding embodiments of a network node adapted to perform any of the embodiments of any of the method described herein are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 and FIG. 2 show the different aspects of the Authentication and Key Management for Applications (AKMA) shared secret key (K_{AF}) retrieval process currently defined in Third Generation Partnership (3GPP) specifications;

FIG. 3 illustrates one example of a cellular communications system in which embodiments of the present disclosure may be implemented;

FIG. 4 illustrates an AKMA architecture for one example embodiment of the cellular communications system of FIG. 3;

FIGS. 5A and 5B are Service Based Architecture (SBA) representations of the AKMA architecture of FIG. 4 for scenarios in which the Application Function (AF) is an internal AF and an external AF;

FIG. 6 illustrates a procedure for K_{AF} generation from K_{AKMA} for the internal AF in which the AKMA Anchor Function (AAnF) verifies the received AF ID in accordance with one example embodiment of the present disclosure;

FIG. 7 illustrates a procedure for K_{AF} generation from K_{AKMA} for the AF in which the AAnF verifies the received AF_ID in accordance with another example embodiment of the present disclosure;

FIG. 8 illustrates a procedure for K_{AF} generation from K_{AKMA} for the external AF in which the AAnF verifies the received AF_ID in accordance with one example embodiment of the present disclosure;

FIGS. 9, 10, and 11 are schematic block diagrams of example embodiments of a network node.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

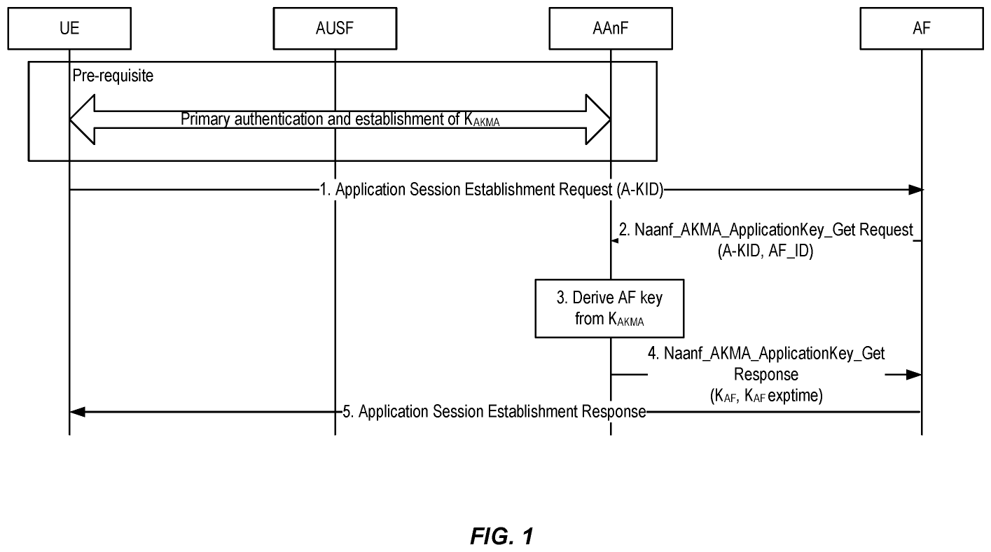

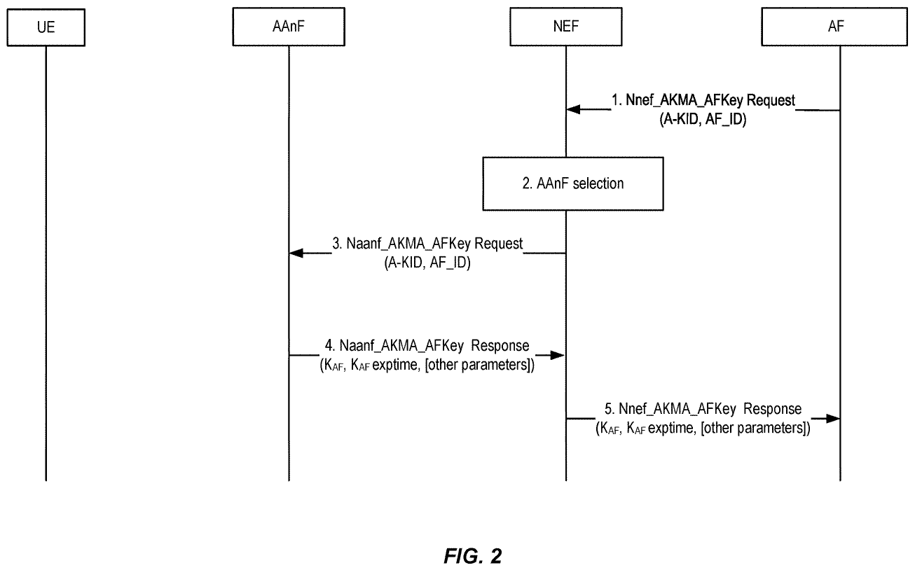

There exist certain problems with the current AKMA solution. The AF_ID is used for authorization decisions by the AAnF as well as for the key derivation of the shared secret K_{AF}. As a result, the AF_ID is an important parameter to be passed to the AAnF. As stated above, the AF_ID includes the FQDN of the AF and a Ua* protocol identifier. Therefore, the AF_ID is associated with the AF itself which passes this as a parameter to a service invocation. From a security point of view, the AAnF should verify that the AF is authorized to use the AF_ID in an AKMA interaction so as to avoid any other AF impersonating the specific AF with the specific AF_ID. However, such verification does not exist in the standards. In particular, in the procedure of FIG. 1, the AAnF needs to verify that the AF is authorized to use AF_ID provided as a parameter in the Naanf_AKMA_ApplicationKey_Get Request. In the procedure of FIG. 2, the NEF needs to verify that the AF is authorized to use AF_ID provided as a parameter in the Nnef_AKMA_ApplicationKey_Get Request. In this case, the interaction between the AF and the NEF may be proprietary, but the typical case involves a TLS connection between the NEF and the AF.

The TLS certificates for SBA NF does not specify details for internal AF. The CCA do not contain any information about the AF_ID or the AF FQDN either. The only identification of the AF (cNF) in the CCA is the NF instance ID which is a Universally Unique Identifier (UUID) and not a FQDN. Therefore, the AAnF (pNF) cannot directly verify that the AF that passed the AF_ID as a parameter in the SBA service operation is indeed authorized to use the AF_ID, based on the TLS certificates or the CCA or the authorization token that the AF presents.

For the external AF case, the AAnF cannot directly authenticate or identify the external AF or whether the external AF can be authorized to use the AF_ID.

Systems and methods that address the aforementioned and/or other problems are disclosed herein. In one embodiment, it is proposed that the certificate (e.g., TLS certificate or security certificate such as, e.g., X.509 public key certificate) and/or the CCA include the FQDN or the full AF_ID of the cNF (AF) or the pNF (AAnF) discovers the FQDN of the cNF, e.g., by querying the NRF using the NF Instance ID, when an AKMA SBA service operation is invoked. Note that while the description herein focuses on a TLS certificate as one example of a certificate, it is to be understood that other types of certificates (e.g., an X.509 public key certificate) for securing communication (e.g., a TLS connection) between the AAnF and the AF and/or other types of certificates for signing CCA in the case of indirect communication between the AAnF and the AF can be used.

In one embodiment, the pNF uses the TLS or CCA information or authorization token information to verify the association between the AF_ID (parameter of the SBA service operation) and the internal AF (cNF) that invokes the service operation. In one embodiment, the FQDN part of the AF_ID or the AF_ID information “as is” is included as part of the TLS or CCA or authorization token. In another embodiment, the AF_ID or parts of it can be discovered by the cNF (AF), e.g., by querying the NRF.

In one embodiment, the pNF uses the Hyper-Text Transfer Protocol (HTTP) header or token sent by the NEF to verify the association between the AF_ID (parameter of the SBA service operation) and the external AF.

Embodiments of the present disclosure may provide a number of advantages of the existing solutions. For example, from a security point of view, embodiments of the present disclosure may enable the AAnF to verify that the AF is authorized to use the AF_ID in an AKMA interaction so as to avoid any other AF impersonating the specific AF with the specific AF_ID.

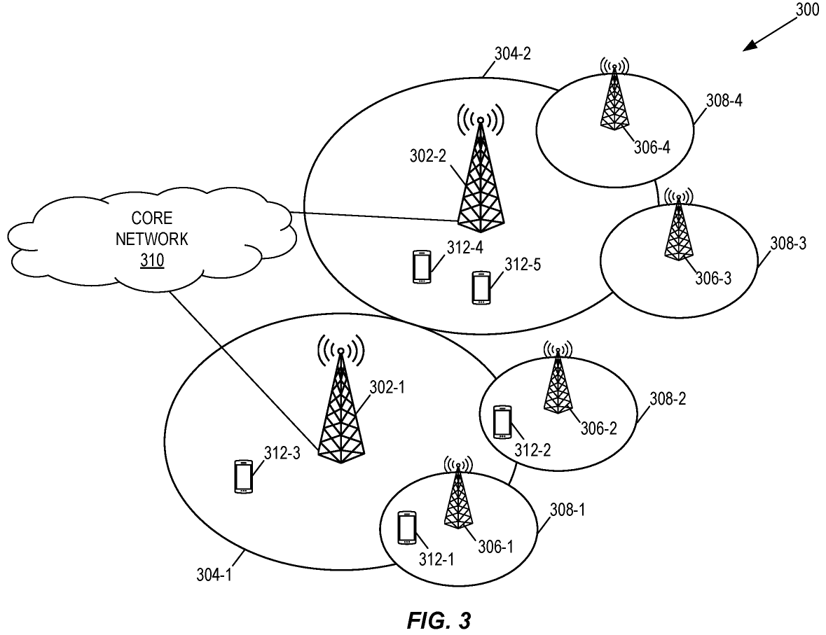

FIG. 3 illustrates one example of a cellular communications system 300 in which embodiments of the present disclosure may be implemented. In the embodiments described herein, the cellular communications system 300 is a 5G system (5GS) including a Next Generation RAN (NG-RAN) and a 5G Core (5GC); however, the embodiments described herein may be utilized in other types of cellular or wireless communications systems that implement Authentication and Key Management for Applications (AKMA) or some similar technology. In this example, the RAN includes base stations 302-1 and 302-2, which in the 5GS include NR base stations (gNBs) and optionally next generation eNBs (ng-eNBs) (e.g., LTE RAN nodes connected to the 5GC), controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or RRHs, or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5G System (5GS) is referred to as the 5GC. The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs and as such sometimes referred to herein as UEs 312, but the present disclosure is not limited thereto.

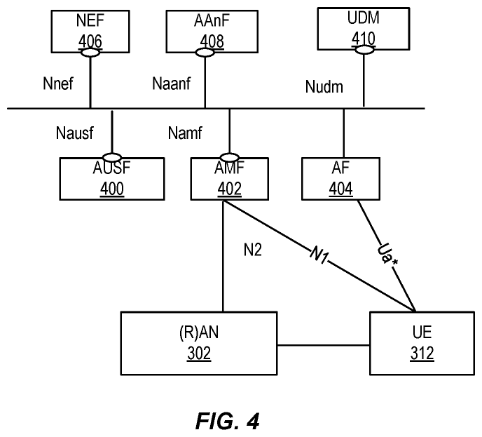

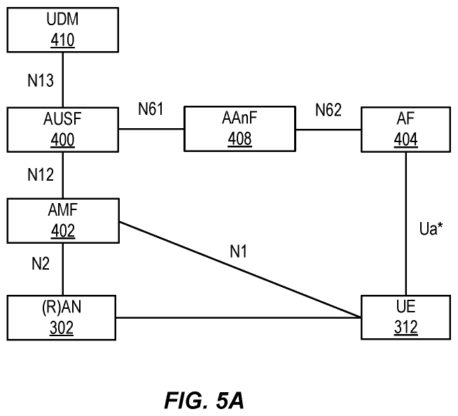

FIG. 4 illustrates a wireless communication system represented as a 5G network architecture (specifically a reference architecture for AKMA) composed of core Network Functions (NFs), where the representation of FIG. 4 uses service-based interfaces between the NFs in the Control Plane (CP), instead of the point-to-point reference points/interfaces used in the 5G network architectures of FIGS. 5A and 5B discussed below. FIG. 4 can be viewed as one particular implementation of the system 300 of FIG. 3. As illustrated in FIG. 4, the 5G network architecture for AKMA includes the UE(s) 312, the RAN represented by base station(s) 302, an AUSF 400, an AMF 402, an AF 404, a NEF 406, a AAnF 408, and a UDM 410. Importantly, the AF 404 may be either an internal AF (i.e., an AF that is seen as being internal to or trusted by the 5GC) or an external AF (i.e., an AF that is seen as being external to or untrusted by the 5GC).

As described in 3GPP TS 33.535, the NFs in the 5G network architecture of FIG. 4 operate as follows in regard to AKMA:
AAnF 408: The AAnF 408 is the anchor function in the Home Public Land Mobile Network (HPLMN). The AAnF stores the AKMA Anchor Key (K_{AKMA}) for AKMA service, which is received from the AUSF 400 after the UE 312 completes a successful 5G primary authentication. The AAnF 408 also generates the key material to be used between the UE 312 and the AF 404 and maintains UE AKMA contexts.
AF: The AF 404 is defined in 3GPP TS 23.501 with the following additional functions:
   The AF 404 with the AKMA service enabling requests for AKMA Application Key, called K_{AF}, from the AAnF 408 using A-KID.
   The AF 404 is authenticated and authorized by the operator network before providing the K_{AF} to the AF 404.
   The AF 404 located inside the operator's network performs the AAnF selection.
NEF 406: The NEF 406 is defined in 3GPP TS 23.501 with additional functions:
   The NEF 406 enables and authorizes the external AF 408 assessing AKMA service and forwards the request towards the AAnF 408.
   The NEF 406 performs the AAnF selection.
AUSF 400: The AUSF 400 is defined in 3GPP TS 23.501 with additional functions:
   The AUSF 400 provides the Subscription Permanent Identifier (SUPI) and AKMA key material (A-KID, K_{AKMA}) of the UE to the AAnF 408.
   The AUSF 400 performs the AAnF selection.
UDM 410: The UDM 410 is defined in 3GPP TS 23.501 with the additional functions:
   The UDM 410 stores AKMA subscription data of the subscriber.

FIGS. 5A and 5B illustrate reference point architectures for the AKMA architecture in which the AF 404 is an internal AF denoted as 404-I (FIG. 5A) and an external AF denoted as 404-E (FIG. 5B).

Note that an NF may be implemented either as a network element on a dedicated hardware, as a software instance running on a dedicated hardware, or as a virtualized function instantiated on an appropriate platform, e.g., a cloud infrastructure.

Now, the description will turn to a number of embodiments of the present disclosure.

### Embodiment #1

In this embodiment, the either or both of the following information is assumed to be provisioned to one of the information elements (TLS certificates, CCA, or authorization tokens) that the AAnF 408 receives from the AF 404 (internal AF 404-I or external AF 404-E) directly or indirectly as part of the AKMA procedures:
a) Specific FQDN of the AF 404 or FQDN with wildcards or sets of these, for example AF123.akma.operator_domain_name, AF3*.akma.operator_domain_name, *.akma.operator_domain_name, {AF123.akma.operator_domain_name, AF345.akma.operator_domain_name, AF3*.akma.operator_domain_name}. The meaning of the set of AF identities as well as the wildcard identities in one of the information elements such as the TLS certificate is the following. The set or the wildcard identities provide the information about what possible identities the AF 404 can assume. The AF 404 could have two different FQDNs or its FQDN may follow a pattern expressed with a wildcard. However, the AKMA provided parameter AF_ID may have a specific value which may be part of the set of specific identities or an AF_ID that matches one of the wildcard identities. The wildcard “*” means that the AAnF 404 will trust any AF that provides a valid AF_ID.
b) Specific AF_ID in the format desired by AKMA e.g., “FQDN|Ua* protocol identifier” or AF_ID with wildcards in the FQDN or the Ua* protocol identifier fields or sets of these. For example, the AE-ID may be: AF123.akma.operator_domain_name|Ua*1, *.akma.operator_domain_name|Ua*1, AF123.akma.operator_domain_name|*, or {AF123.akma.operator_domain_name|0×80, AF1*.akma.operator_domain_name|*}. The wildcards are used for allowing the AAnF 408 to make the decision of whether the AF 404 is allowed to use the AF_ID with a more flexible/simpler lifecycle management for the TLS certificates or CCA for the AFs, e.g., when the AF 404 is instantiated it does not have to create a new TLS certificate if the certificate includes wildcards and the AAnF 408 can accept wildcards.

As stated before, this kind of information is included in the TLS certificate for connectivity or the TLS certificate for signing a CCA, or the CCA itself, or the authorization token.

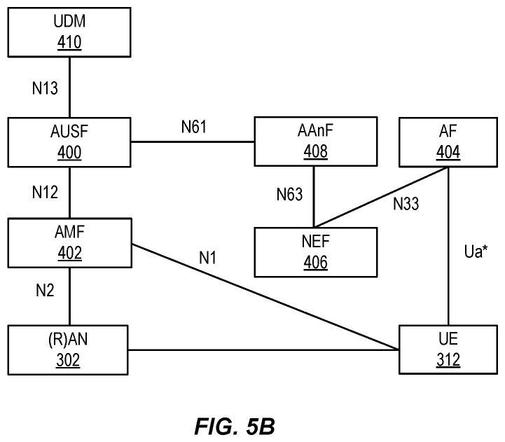

FIG. 6 illustrates a procedure for K_{AF} generation from K_{AKMA} for the internal AF 404-I in which the AAnF 408 verifies the received AF_ID in accordance with one example embodiment of the present disclosure. The steps of the procedure are as follows.

Step 600: A UE 312 sends an Application Session Establishment Request message comprising an A-KID to the AF 404.

Step 602: In Step 602, at the AF 404, the TLS certificate of the communication or the certificate signing the CCA or the CCA itself or the authorization token is provisioned with the FQDN or AF_ID information. Note that step 602 may alternatively be done before step 600.

Step 604: The AF 404 sends an Naanf_AKMA_ApplicationKey_Get_Request message to the AAnF 408. This request message includes the A-KID and AF_ID.

Step 606: In step 606, the AAnF 408 checks if the supplied parameter AF_ID and the TLS certificate, or CCA information, or authorization token, or asserted AF information match. By “match”, the following is meant: (1) an exact match, a partial match or wildcard match, or (3) a match by local rule, e.g., AAnF has a local policy that says that “A.akma.com” matches “B.3gpp.org”. As an example, a “match” may be as follows:
1) If the TLS certificate, or CCA information, or authorization token includes a set of FQDNs, this FQDN information is matched against the FQDN information of the supplied AF_ID in the request message of step 604. If the TLS certificate/CCA information/authorization token includes a set of AF_IDs, this AF_ID information is matched against the supplied AF_ID in the request message received in step 604.
2) If at least one member of the set of FQDNs/AF_IDs included in the TLS certificate/CCA information/authorization token matches the supplied FQDN/AF_ID, then the AAnF 408 determines that the AF 404 is authorized to use the supplied AF_ID. If the AAnF 408 determines that the AF 404 is authorized to use the supplied AF_ID, the process continues as illustrated. Otherwise, in one embodiment, the request is rejected and, e.g., a corresponding reject message is sent to the AF 404.

Steps 608-612: If the AAnF 408 determines that the AF 404 is authorized to use the supplied AF_ID, the AAnF 408 derives the AF key (K_{AF}) from K_{AKMA} and sends a Naanf_AKMA_ApplicationKey_Get_Response message including K_{AF} to the AF 404. The AF 404 then sends an Application Session Establishment Response message to the UE 312.

### Embodiment #2

In this embodiment, the TLS certificate or the CCA includes only the NFInstance ID of the AF 404 or, in other words, its specification is left unchanged. Another NF (e.g., NRF) maintains a mapping between the NFInstance ID and the AF FQDN or AKMA AF_ID (e.g., the concatenation of the FQDN and the Ua* protocol identifier). The mapping is managed (added, deleted, or modified) by the operations and management system (O&M) that also manages the lifecycle of the AF 404.

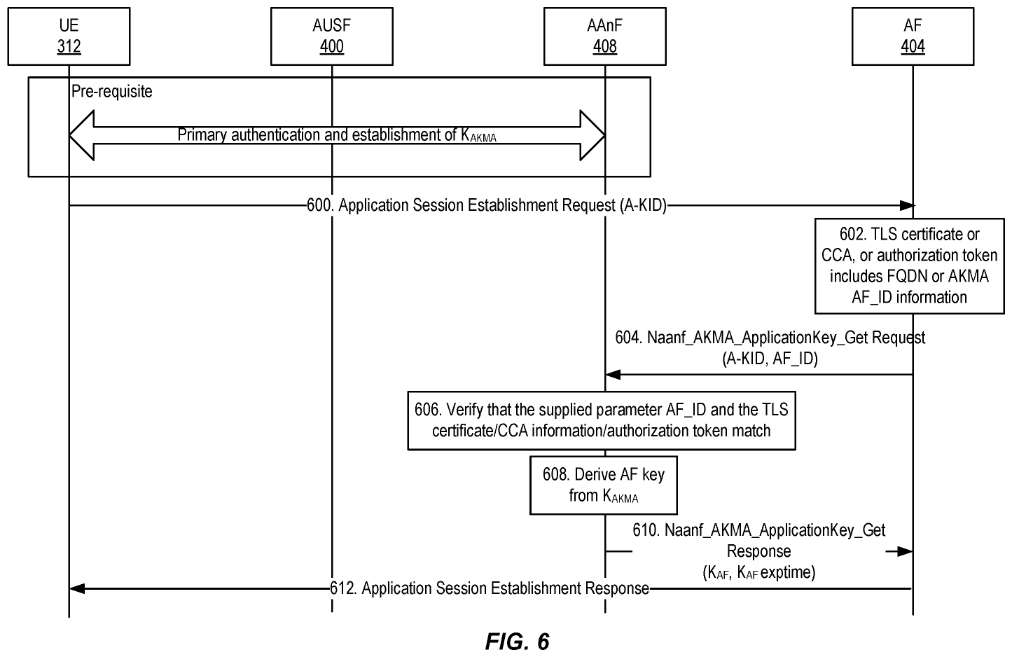

FIG. 7 illustrates a procedure for K_{AF} generation from K_{AKMA} for the AF 404 in which the AAnF 408 verifies the received AF_ID in accordance with another example embodiment of the present disclosure. In this example embodiment, the architecture further includes an O&M system 700 and a mapping NF 702. The steps of the procedure of FIG. 7 are as follows.

Steps 704-706: Steps 704 and 706 take place when the AF 404 is created and assigned a FQDN and TLS certificates and/or CCA information. The O&M system 700, for example, that orchestrates the AF lifecycle associates the NFInstanceID with the AF 404 and the FQDN or AF_ID (e.g., the concatenation of the FQDN and the Ua* protocol) and pushes such association to another NF which in this example is the Mapping NF 702. The mapping NF 702 can be a new NF or an existing NF such as, e.g., the NRF. Also note that, the mapping NF 702 or the functionality of the mapping NF 702 described herein may alternatively be incorporated into the AAnF 408. In one embodiment, an association in general includes two main parts {NFinstanceID information, FQDN or AF_ID information}. The meaning of the association {NFinstanceID1, FQDN1 or AF_ID1} is that the NF/AF with the NFInstanceID1 identifier is allowed to use the FQDN1 or AKMA AF_ID1 information. The NFInstanceID is taken from the corresponding information from the TLS certificates of the NFs or the CCA. The Mapping NF 702 maintains all the aforementioned associations in a database. As in embodiment #1, the FQDN or the AF_ID may contain wildcards according to the configuration of the O&M function. Examples of associations are {NFInstanceID, AF123.akma.operator_domain_name}, {NFInstanceID, {AF1*.akma.operator_domain_name, AF345.akma.operator_domain_name, AF567.akma.operator_domain_name|*}}. The association database could contain NFInstance ID wildcards e.g. {123*, *}, which means that an AF with an NFinstanceID starting with “123” is allowed to use any FQDN and/or AF_ID.

If CCA information is used, the Mapping NF 702 is provisioned with corresponding information, i.e. CCA unique information such as, e.g., that is defined in clause 13.3.8.2 of 3GPP TS 33.501 and, therefore, the association records are of the form {CCA unique information, FQDN or AF_ID information}. One example of unique information is the NF instance ID of the service consumer.

Step 708: A UE 312 sends an Application Session Establishment Request message comprising an A-KID to the AF 404.

Step 710: The AF 404 sends an Naanf_AKMA_ApplicationKey_Get_Request message to the AAnF 408. This request message includes the A-KID and AF_ID.

Step 712: When the AAnF 408 receives the request for an application key in step 710, the AAnF 408 contacts the Mapping NF 702 to verify the AF_ID supplied by the AF 404 in the request by providing the supplied AF_ID as a parameter to a verification service provided by the Mapping NF 702. In one embodiment, the AAnF 404 also provides, to the Mapping NF 702, the NFInstanceID of the cNF (i.e., the AF 404) if the cNF has used a TLS certificate or CCA information. If the cNF supplies a CCA, then the CCA unique information is supplied to the Mapping NF 702. The NFInstanceID is taken from the TLS certificate and the CCA unique information (e.g., NFInstance ID or other CCA unique information) is taken from the CCA. The Mapping NF 702 retrieves the mapping records for the supplied NFInstanceID or the CCA unique information and checks if the supplied AF_ID matches the AF_ID part of the association information. In one embodiment, the Mapping NF 702 sends a response to the AAnF 408 that indicates whether the AF 404 is authorized to use the supplied AF_ID. In another embodiment, the Mapping NF 702 sends a response to the AAnF 408 that includes information (e.g., NFInstanceID or CCA unique information stored in association with the supplied AF_ID) that enables the AAnF 408 to determine whether the AF 404 is authorized to use the supplied AF_ID. If so, the AAnF 408 determines that the AF 404 is authorized to use the supplied AF_ID. Otherwise, the AAnF 408 determines that the AF 404 is not authorized to use the supplied AF_ID. If the AAnF 408 determines that the AF 404 is authorized to use the supplied AF_ID, the process continues as illustrated. Otherwise, in one embodiment, the request is rejected and, e.g., a corresponding reject message is sent to the AF 404.

Steps 714-718: If the AAnF 408 determines that the AF 404 is authorized to use the supplied AF_ID, the AAnF 408 derives the AF key (K_{AF}) from K_{AKMA} and sends a Naanf_AKMA_ApplicationKey_Get_Response message including K_{AF} to the AF 404. The AF 404 then sends an Application Session Establishment Response message to the UE 312.

### Embodiment #3

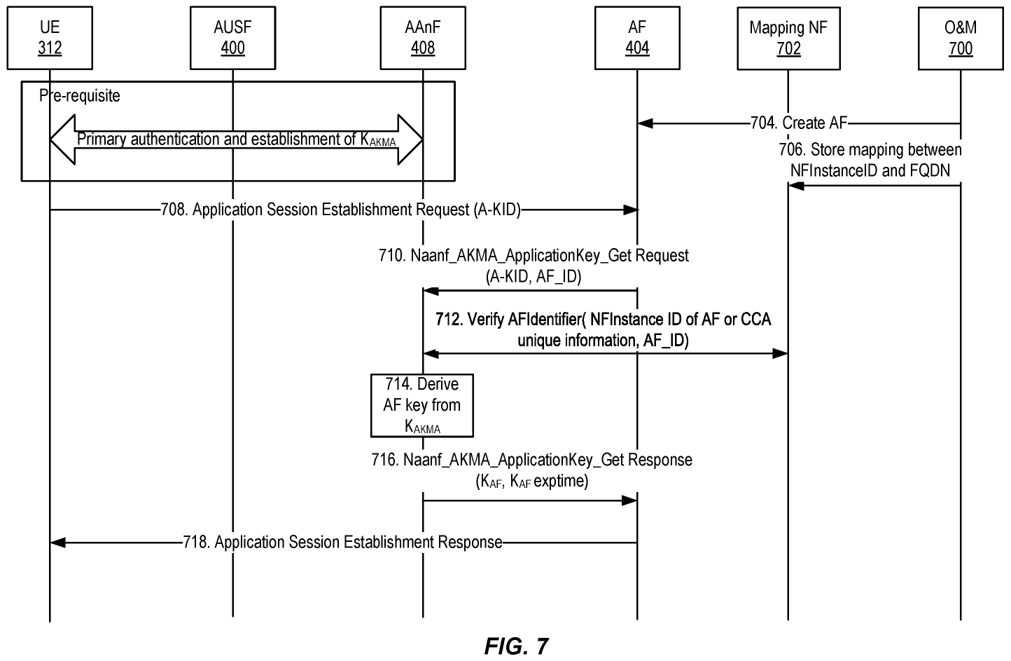

FIG. 8 illustrates a procedure for K_{AF} generation from K_{AKMA} for the external AF 404-E in which the AAnF 408 verifies the received AF_ID in accordance with one example embodiment of the present disclosure. The steps of the procedure are as follows.

Step 800: An AF 404 is accessing AKMA service and presents a token which identifies the AF identity (AF_ID). The token could be, e.g., a JSON Web Token (JWT) as specified in IETF RFC 7519, digitally signed using JWS as specified in IETF RFC 7515. The token contains, e.g., the AF FQDN or Ua* protocols it supports.

Steps 802-804: The NEF 406 verifies the token if received. The NEF 406 may authenticate the AF 404 based on the existing defined method as per 3GPP TS 33.501. The NEF 404 determines the FQDN of the AF 404 either based on the token info or from the authentication result.

Step 806: The NEF 404 performs AAnF selection as defined in 3GPP TS 33.535.

Step 808: The NEF 404 sends the determined AF FQDN or the token or both to the AAnF 408 together with the AF_ID received in the message from step 800. The determined AF FQDN could be sent, e.g., via a 3GPP specific HTTP header, e.g. 3gpp-Sbi-Asserted-AF-FQDN.

Step 810: The AAnF 408 checks if the supplied parameter AF_ID in the Naanf_AKMA_AFKey_Request message and the token or the determined AF FQDN match. By “match” the same principle applies as in embodiment #1. If there is a match, the AAnF 408 determines that the AF 404 is authorized to use the supplied AF_ID. Otherwise, the AAnF 408 determines that the AF 404 is not authorized to use the supplied AF_ID. If the AAnF 408 determines that the AF 404 is authorized to use the supplied AF_ID, the process continues as illustrated. Otherwise, in one embodiment, the request is rejected and, e.g., a corresponding reject message is sent to the AF 404, e.g., via the NEF 406.

Steps 812-814: If the AAnF 408 determines that the AF 404 is authorized to use the supplied AF_ID, the AAnF 408 derives the AF key (K_{AF}) from K_{AKMA} and sends a Naanf_AKMA_ApplicationKey_Get_Response message including K_{AF} to NEF 406, which forward the response message to the AF 404.

### Additional Description

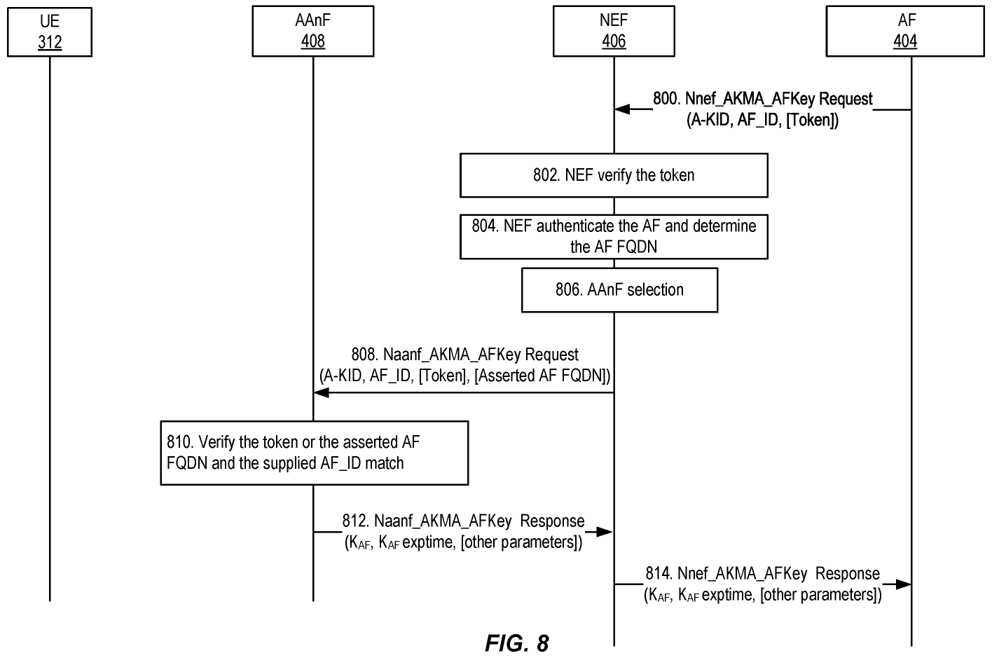

FIG. 9 is a schematic block diagram of a network node 900 according to some embodiments of the present disclosure. Optional features are represented by dashed boxes. The network node 900 may be, for example, a core network node that implements a NF (e.g., AAnF 408, NEF 406, AF 404, Mapping NF 702, or the like) or a network node that implements all or part of the functionality of an NF (e.g., all or part of the functionality of the AAnF 408, NEF 406, AF 404, Mapping NF 702, or the like, as described herein). As illustrated, the network node 900 includes a one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. The one or more processors 904 operate to provide one or more functions of the network node 900 as described herein (e.g., one or more functions of the AAnF 408, NEF 406, AF 404, or Mapping NF 702, described herein). In some embodiments, the function(s) are implemented in software that is stored, e.g., in the memory 906 and executed by the one or more processors 904.

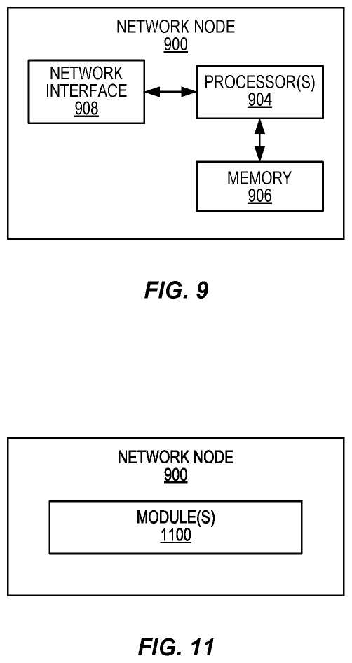

FIG. 10 is a schematic block diagram that illustrates a virtualized embodiment of the network node 900 according to some embodiments of the present disclosure. Again, optional features are represented by dashed boxes. As used herein, a “virtualized” network node is an implementation of the network node 900 in which at least a portion of the functionality of the network node 900 is implemented as a virtual component(s) (e.g., via a virtual machine(s) executing on a physical processing node(s) in a network(s)). As illustrated, in this example, the network node 900 includes one or more processing nodes 1000 coupled to or included as part of a network(s) 1002. Each processing node 1000 includes one or more processors 1004 (e.g., CPUs, ASICS, FPGAs, and/or the like), memory 1006, and a network interface 1008. In this example, functions 1010 of the network node 900 described herein (e.g., one or more functions of the AAnF 408, NEF 406, AF 404, or Mapping NF 702, described herein) are implemented at the one or more processing nodes 1000 or distributed across the two or more processing nodes 1000 in any desired manner. In some particular embodiments, some or all of the functions 1010 of the network node 900 described herein are implemented as virtual components executed by one or more virtual machines implemented in a virtual environment(s) hosted by the processing node(s) 1000.

In some embodiments, a computer program including instructions which, when executed by at least one processor, causes the at least one processor to carry out the functionality of the network node 900 or a node (e.g., a processing node 1000) implementing one or more of the functions 1010 of the network node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

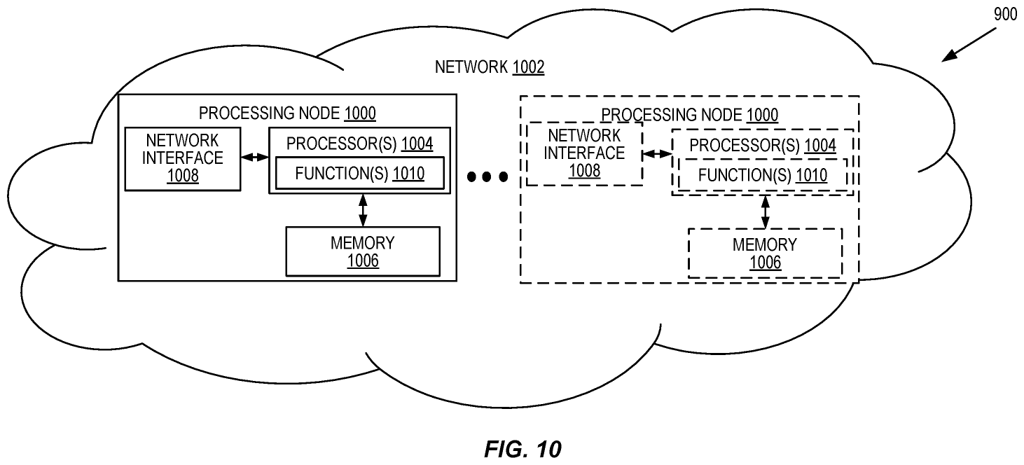

FIG. 11 is a schematic block diagram of the network node 900 according to some other embodiments of the present disclosure. The network node 900 includes one or more modules 1100, each of which is implemented in software. The module(s) 1100 provide the functionality of the network node 900 described herein. This discussion is equally applicable to the processing node 1000 of FIG. 10 where the modules 1100 may be implemented at one of the processing nodes 1000 or distributed across multiple processing nodes 1000.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by an Authentication and Key Management for Applications, AKMA, Anchor Function, AAnF, in a core network of the cellular communications system for generating a shared secret key for AKMA, the method comprising:
receiving, directly or indirectly from an Application Function, AF, a request for a shared secret key for AKMA, the request comprising an AF ID;
determining whether the AF is authorized to use the AF ID; and
performing one or more actions based on a result of determining whether the AF is authorized to use the AF ID.

2. The method of claim 1 wherein the AF ID comprises an AF Fully Qualified Domain Name, FQDN, and a Ua* protocol identifier.

3. The method of claim 1 wherein an associated certificate comprises information comprising: (a) a AF FQDN, (b) information that indicates a set of AF FQDNs, (c) an AF ID, (d) information that indicates a set of AF IDs, or (e) a combination of any two or more of (a)-(d).

4. The method of claim 3 wherein the associated certificate is a certificate used for securing communication between the AAnF and the AF in the case of direct communication between the AAnF and the AF or a certificate used for signing Client Credentials Assertions, CCA, in the case indirect communication between the AAnF and the AF.

5. The method of claim 3 wherein determining whether the AF is authorized to use the AF ID comprises determining whether the AF is authorized to use the AF ID based on a comparison of the AF ID comprised in the request for the shared secret key for AKMA and the information comprised in the associated certificate.

6. The method of claim 5 wherein determining whether the AF is authorized to use the AF ID based on the comparison of the AF ID comprised in the request for the shared secret key for AKMA and the information comprised in the associated certificate comprises determining that the AF is authorized to use the AF ID if there is a match between the AF ID comprised in the request for the shared secret key for AKMA and the information comprised in the associated certificate.

7. The method of claim 1 wherein associated Client Credentials Assertions, CCA, comprise information comprising: (a) a AF FQDN, (b) information that indicates a set of AF FQDNs, (c) an AF ID, (d) information that indicates a set of AF IDs, or (e) a combination of any two or more of (a)-(d).

8. The method of claim 7 wherein the associated CCA are CCA associated to hop by hop Transport Layer Security, TLS, connections in the case of indirect communication between the AAnF and the AF.

9. The method of claim 7 wherein determining whether the AF is authorized to use the AF ID comprises determining whether the AF is authorized to use the AF ID based on a comparison of the AF ID comprised in the request for the shared secret key for AKMA and the information comprised in the associated CCA.

10. The method of claim 9 wherein determining whether the AF is authorized to use the AF ID based on the comparison of the AF ID comprised in the request for the shared secret key for AKMA and the information comprised in the associated CCA comprises determining that the AF is authorized to use the AF ID if there is a match between the AF ID comprised in the request for the shared secret key for AKMA and the information comprised in the associated CCA.

11. The method of claim 1 wherein an associated authorization token comprises information comprising: (a) a AF FQDN, (b) information that indicates a set of AF FQDNs, (c) an AF ID, (d) information that indicates a set of AF IDs, or (e) a combination of any two or more of (a)-(d).

12. The method of claim 11 wherein the associated authorization token is an authorization token presented to the AAnF upon invocation of an associated AKMA service.

13. The method of claim 11 wherein determining whether the AF is authorized to use the AF ID comprises determining whether the AF is authorized to use the AF ID based on a comparison of the AF ID comprised in the request for the shared secret key for AKMA and the information comprised in the associated authorization token.

14. The method of claim 13 wherein determining whether the AF is authorized to use the AF ID based on the comparison of the AF ID comprised in the request for the shared secret key for AKMA and the information comprised in the associated authorization token comprises determining that the AF is authorized to use the AF ID if there is a match between the AF ID comprised in the request for the shared secret key for AKMA and the information comprised in the associated authorization token.

15. The method of claim 1 wherein determining whether the AF is authorized to use the AF ID comprises determining whether the AF is authorized to use the AF ID based on asserted AF information.

16. The method of claim 1 wherein determining whether the AF is authorized to use the AF ID comprises:
providing a verification request to a mapping network function, NF, the verification request comprising the AF ID; and
receiving a verification response from the mapping NF.

17. The method of claim 16 wherein the verification response comprises information that indicates whether the AF is authorized to use the AF ID.

18. The method of claim 16 wherein determining whether the AF is authorized to use the AF ID further comprises determining whether the AF is authorized to use the AF ID based on the verification response.

19. The method of any of claim 16 wherein the verification request further comprises an Instance ID of the AF.

20. The method of claim 19 wherein the mapping NF stores associations between Instance IDs and AF IDs, sets of AF IDs, FQDNs, or sets of FQDNs.

21. The method of claim 16 wherein the verification request further comprises CCA unique information associated to the AF.

22. The method of claim 21 wherein the mapping NF stores associations between CCA unique information and AF IDs or sets of AF IDs, or FQDNs, or sets of FQDNs.

23. The method of claim 1 wherein:
determining whether the AF is authorized to use the AF ID comprises determining that the AF is authorized to use the AF ID; and
performing the one or more actions based on the result of determining whether the AF is authorized to use the AF ID comprises, responsive to determining that the AF is authorized to use the AF ID:
deriving the shared secret key for AKMA; and
sending, directly or indirectly to the AF, a response message that comprises the shared secret key for AKMA.

24. A method performed by mapping network function, NF, in a core network of the cellular communications system, the method comprising:
receiving a verification request from an Authentication and Key Management for Applications, AKMA, Anchor Function, AAnF, the verification request comprising an Application Function identity, AF ID;
determining whether a particular AF is authorized to use the AF ID; and
sending a verification response to the AAnF, the verification response comprising information that indicates whether the particular AF is authorized to use the AF ID.

25. The method of claim 24 wherein the verification request further comprises a NF Instance ID of the particular AF, and determining whether the particular AF is authorized to use the AF ID comprises determining whether the particular AF is authorized to use the AF ID based on the NF Instance ID of the particular AF and stored associations between NF Instance IDs and AF IDs or sets of AF IDs.

26. The method of claim 24 wherein the verification request further comprises CCA unique information associated to the particular AF, and determining whether the particular AF is authorized to use the AF ID comprises determining whether the particular AF is authorized to use the AF ID based on the CCA unique information associated to the particular AF and stored associations between CCA unique information and AF IDs or sets of AF IDs.

27. (canceled)
